(19) United States
(12) Patent Application Publication
(10) Pub. No.: US 2002/0101401 A1
(43) Pub. Date: Aug. 1, 2002

(54) Thumb mounted function and cursor control device for a computer

(76) Inventor: Mehran Movahed, Beverly Hills, CA (US)

Correspondence Address: ALAN R. DAVIS, 14619 LA MAIDA STREET, SHERMAN OAKS, CA, 91403, US

(21) Appl. No.: 09/976,179

(22) Filed: Oct. 12, 2001

Related U.S. Application Data
(60) Provisional application No. 60/264,442, filed on Jan. 29, 2001.

(51) Int. Cl. G09G 5/00; G09G 5/08

(52) U.S. Cl. 345/156; 345/158

(57) ABSTRACT

The invention is a thumb mountable control device for a computer including a mounting sleeve for mounting about the base of the thumb. A support member is pivotally mounted to the mounting sleeve, the support member having a palm facing portion and an end portion for covering the end of the thumb and a side portion facing the index finger. A button for controlling mouse function switching is mounted on the end of the support member. A device, such as touch pad, for controlling cursor movement is mounted on the palm-facing portion of the support member. A transmitter is mounted on the sleeve for transmitting the control signals from the mouse to the computer.

### BACKGROUND OF THE INVENTION

1. Field of the Invention

The invention relates to the field of personal computers and the like and, in particular, to a thumb mounted device that functions as a mouse.

2. Description of Related Art

The typical mouse for a personal computer and the like comprises a housing having a roller ball and one or more actuation buttons and is connected to the computer by an electrical line. The mouse when moved over a flat surface causes the cursor on the screen to move and the button(s) cause the computer to execute functions indicated by the cursor. Another method of controlling the computer is to use a roller ball. Here the “mouse” remains stationary and movement of the ball by hand positions the cursor. Another approach for portable computers a uses short swiveling button mounted on the keyboard. Another approach, again used primarily with portable computers, is to a touch pad. Here one can move the cursor by moving a finger across the touch pad. All these devices require the computer operator to move one of his or her hands to the device to move the cursor and/or depresses a function button.

In U.S. Pat. No. 6,154,199 Hand Positioned Mouse by C. L. Butler disclosed a fingerless glove having exposed fingers. The glove includes an index finger portion that extends near to the second joint and incorporates a roller ball that can be actuated by side movement of the thumb. A pair of pad like buttons are positioned in the palm portion of the glove. A transmitter is mounted on the backside of the glove for transmitting signals to the computer. This device allows the computer user to keep both of his or her hands over the keyboard. However, hand sizes vary greatly making it necessary to stock a large number of glove sizes. In addition, continuously wearing a glove may prove uncomfortable over time.

Thus, it is a primary object of the invention to provide a device to replace the conventional mouse, which can be mounted on the thumb of the user, such that hands do not have to leave the keyboard area.

It is another primary object of the invention to provide a device to replace the conventional mouse, which can be mounted on the thumb of the user such that hands do not have to leave the keyboard area that and which adjusted to fit on different size thumbs.

It is a further object of the invention to provide a device to replace the conventional mouse, which can be mounted on the thumb of the user such that hands to not leave the keyboard area and which is adaptable to the vast majority of men and woman.

### SUMMARY OF THE INVENTION

The invention is a thumb mountable device for controlling the movement of the cursor on the monitor and to control computer program functions by use of buttons. In detail, the invention includes a sleeve for mounting about the base portion of the thumb between the first and second joints. A support member is pivotally mounted to the sleeve, the support member having a palm facing portion, a cap for covering the end of the thumb and a side portion facing in the direction of the index finger. A first computer function device, typically a button, is mounted on the end of the cap. A second computer function device, preferably a touch pad for moving the cursor, is mounted on the palm-facing portion of the support member. A third computer function device, a button, is mounted on the palm-facing portion between the second computer function device and the mounting sleeve. A transmitter is mounted on the sleeve, which is used to transmit signals from the first, second and third computer function devices.

In operation, the computer operator can move the cursor by moving the tip of the index finger or middle finger across the touch pad. Function switching can be also be accomplished by pressing either of the buttons with the tip of the index or middle finger. Which finger is used will depend only upon the preference of the individual. Thus it can be seen that an individual can type on the keyboard and control the position of the cursor and function buttons without moving the hand away from the keyboard.

In a second embodiment of the device, the cursor-moving device is a roller ball or swiveling button mounted on end portion or cap. The first and second computer function control devices (buttons) are mounted on the palm facing portion of the support member.

The novel features which are believed to be characteristic of the invention, both as to its organization and method of operation, together with further objects and advantages thereof, will be better understood from the following description in connection with the accompanying drawings in which the presently preferred embodiments of the invention are illustrated by way of examples. It is to be expressly understood, however, that the drawings are for purposes of illustration and description only and are not intended as a definition of the limits of the invention.

### BRIEF DESCRIPTION OF THE DRAWINGS

FIG. 1 is a view of the device mounted on the thumb of a hand.

FIG. 2 is a partial view of the palm side of the hand with the device mounted on the thumb.

FIG. 3 is a partial side view of the thumb side of the hand with the device mounted on the thumb.

FIG. 4 is an enlarged view of the device shown in FIG. 1 taken along the arrow 4, illustrating the touch pad.

FIG. 5 is a view similar to FIG. 4 illustrating an alternate embodiment.

FIG. 6 is a partial perspective view of the device illustrating an alternate design, wherein an elastic band is used to provide bending capability.

### DESCRIPTION OF THE PREFERRED EMBODIMENT

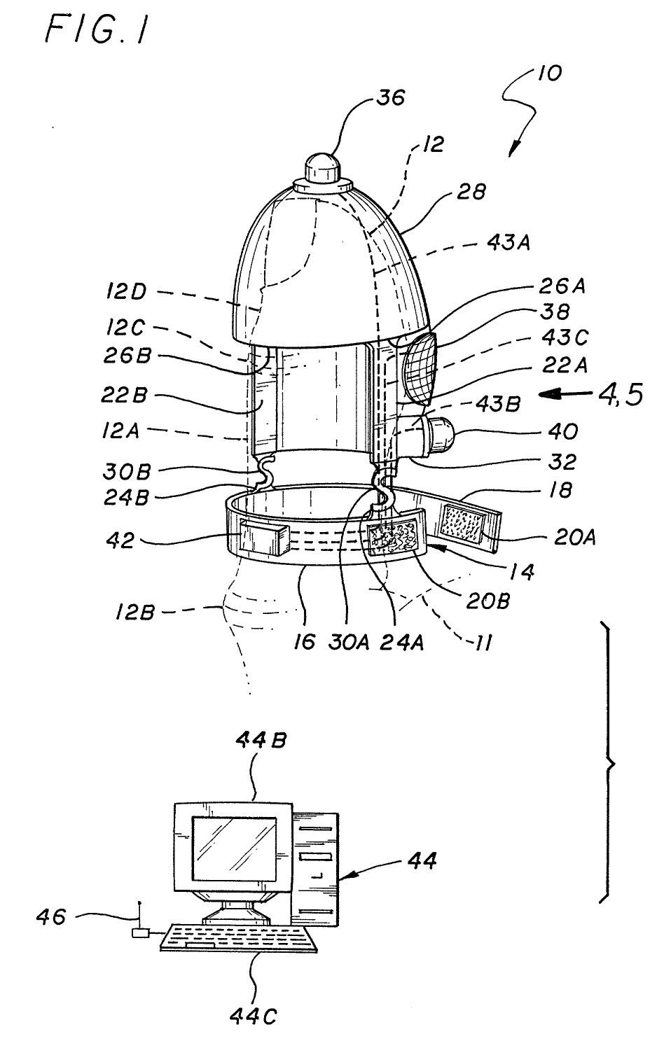

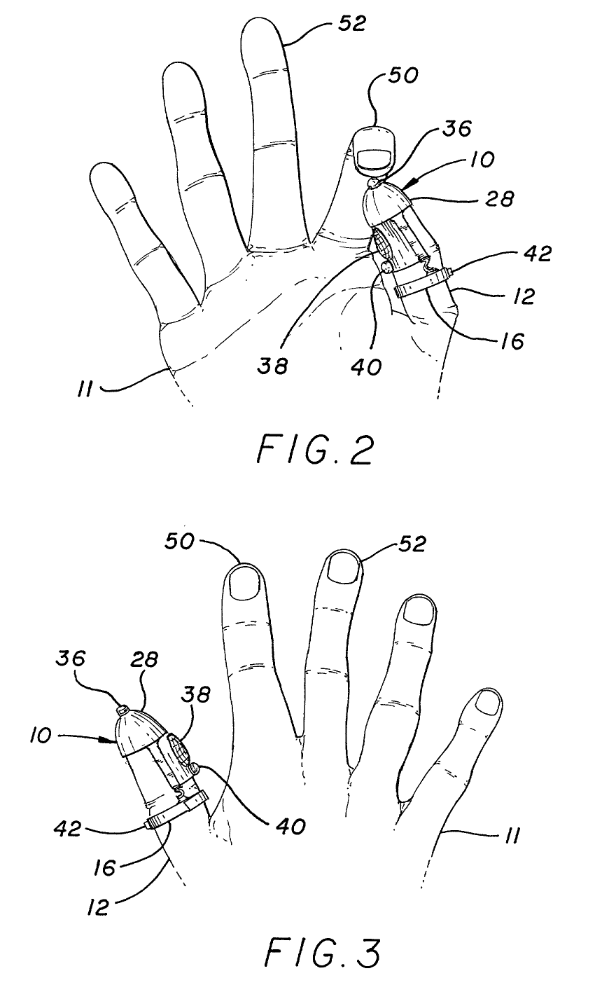

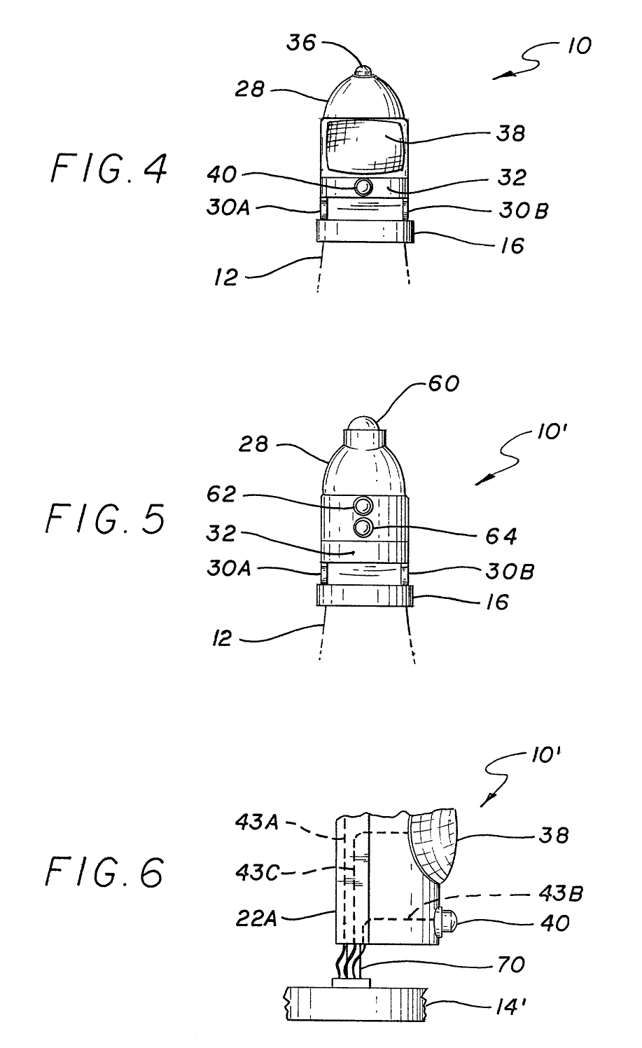

Referring to FIGS. 1-4, the thumb-mounted device is generally designed by numeral 10. The right hand 11 with the thumb 12 is illustrated having a base portion 12A between the first and second joints 12B and 12C, and an end portion 12D of an individual computer user. The assembly 10 includes a strap member 14 for attachment to the base portion 12A of the thumb 12. The strap member 14 includes a semi-flexible band portion 16 (a semi-stiff rubber) having a flexible strap portion 18. Hook and loop type fastener pad halves 20A and 20B are attached to both the band portion 16 and strap portion 18 so that the strap member can be secured to the base portion 12A of the thumb 12. The use of a hook and loop type fastener allows the use of the device 10 on different size thumbs, because the fastener halves do not have exactly align.

A pair of arms 22A and 22B are mounted by their first ends 24A and 24B to the band portion 16 in a spaced relationship and by their second ends 26A and 26B attached to a hollow cap 28, which the end of the thumb 12 fits. The arms 22A and 22B include “S” shaped sections 30A and 30B that allow the arms to bend about the joint 12C of the thumb 12. It will also allow the arms 22A and 22B to extend along the thumb. A support band 32 extends across the two arms 22A and 22B on the palm facing side thereof. The cap member 28 incorporates a first mouse function button 36. A palm facing touch pad 38 for moving the cursor is mounted to the two arms 22A and 22B, the cap 28 and the support band 32. A second mouse function button 40 is mounted to the support band 32. The antenna 42 is mounted on the band portion 16 of the strap member 14. It is connected by wire 43A from the button 28, wire 43B from the button 40 and wire 43C from the touch pad 38 and is used to transmit signals to the computer 44 via receiving antenna 46. The computer 44 as illustrated includes a computer-processing unit 44A, monitor 44B and keyboard 44C.

With the mouse 10 attached to the thumb 12, the index finger 50 can be used to actuate the buttons 36 and 40, while the middle finger 52 can be used with the touch pad 38. The use of the S shaped members 30A and 30B allows the thumb 12 to bend and generally move in all directions. Thus thumb 12 can still be used by the computer operator when typing on the computer keyboard 44C.

Referring to FIG. 5, it is position to install a cursor controlling roller ball 60 on the mouse, now indicated by numeral 10′ at the end of the cap 28 instead of a function button. The two function buttons 62 and 64 can therefore now be located in the location previously used for the touch pad. Here the index finger would be used to control the roller ball 60 and also buttons 62 and 64.

Illustrated in FIG. 6 is an alternate design for the device. In this version, the assembly 10′ includes a sleeve 14′. However, the pair of arms 22A′ and 22B′ are attached by an elastic cable 70 instead of S shaped members. This will allow for bending and an even greater difference in thumb sizes. Of course, any structure that will allow the thumb to freely bend and accommodate different thumb sizes can be used as a support member.

Thus it can be seen that the thumb-mounted mouse can replace conventional mouse designs. It offers the advantage of allowing the computer operator to input data through the keyboard without ever having to move the “mouse hand” away from the keyboard. It can also be used with portable computers (lap tops), also providing a similar advantage.

While the invention has been described with reference to particular embodiments, it should be understood that the embodiments are merely illustrative, as there are numerous variations and modifications, which may be made by those skilled in the art. Thus, the invention is to be construed as being limited only by the spirit and scope of the appended claims.

Industrial Applicability

The invention has applicability to the computer manufacturing industry.

1. A thumb mountable control device for a computer comprising:
a sleeve for mounting about the base portion between the first and second joints of the thumb;
a support member pivotally mounted to said mounting sleeve, said support member having a generally palm facing portion and an end portion for covering the end of the thumb and side portions connecting the end portion to the sleeve;
a first means mounted on said support member for controlling computer function switching;
a second means for controlling cursor movement on the monitor mounted on said support member; and
third means to transmit signals from said first and second means to the computer.

2. The device as set forth in claim 1 wherein:
said first means is mounted on said end portion of said support member; and
said second means mounted on said palm facing portion of said support member.

3. The device as set forth in claim 2 further comprising:
a fourth means for controlling other computer function switching mounted on said palm facing portion of said support member; and
said third means also for transmitting signals form said fourth button to the computer.

4. The device as set forth in claim 1, or 2, or 3, wherein said second means is selected from the group consisting of roller balls, touch pads and button pointers.

5. The device as set forth in claim 4 wherein:
said first and fourth means are buttons; and
said third means is an antenna mounted on said sleeve.

6. The device as set forth in claim 1 wherein
said first means is mounted on said palm facing portion of said support member and is a button;
said second means is mounted on end portion of said support member and is a roller ball; and
said third means is an antenna mounted on said sleeve.

7. The device as set forth in claim 6.
a fourth means for controlling other computer function switching mounted on said palm facing portion of said support member; and
said third means also for transmitting signals form said fourth button to the computer.
